(19) United States
(12) Patent Application Publication
(10) Pub. No.: US 2012/0150592 A1
(43) Pub. Date: Jun. 14, 2012

(54) SYSTEMS AND METHODS FOR USER MARKETING AND ENDORSEMENT ON SOCIAL NETWORKS

(76) Inventors: Endre Govrik, St. Paul, MN (US); Christopher Govrik, Mendota Heights, MN (US); Kirk Larson, St. Paul Park, MN (US); Michael Larson, St. Paul Park, MN (US)

(21) Appl. No.: 13/303,759

(22) Filed: Nov. 23, 2011

Related U.S. Application Data
(60) Provisional application No. 61/422,093, filed on Dec. 10, 2010.

(51) Int. Cl. G06Q 30/02

(52) U.S. Cl. 705/14.1; 705/14.66

(57) ABSTRACT

An endorsement system is provided for enabling a user to manage endorsements and promotions. In an embodiment, the user may be able to embed a logo of a company within the user's profile picture within a social network. Such user, displaying the logo of a company may thus act as an endorser of the company, and in exchange the company may offer the user certain incentives for such endorsement. The endorsement may be viewed by the user's friends of connections within a social network. In one embodiment, the endorsement system includes an administration system, the administration system including one or more modules to permit a user to create a profile, manage the user's profile, and manage endorsements.

### BACKGROUND

Advertising is a form of communication intended to persuade an audience (viewers, readers or listeners) to purchase or take some action upon products, ideas, or services. Advertising can include the name of a product or service, in addition to how that product or service could benefit the consumer, to persuade a target market to purchase or to consume a particular brand. Advertising can be conveyed by way of an advertisement, which is typically paid for by sponsors and viewed via various media. Advertising can also serve to communicate an idea to a large number of people in an attempt to convince them to take a certain action.

In some cases, advertising can be targeted at a niche market using so-called niche or targeted advertisements (“ads”). Such targeted advertising can enable advertisers to reach a target audience, providing advertisers with audiences that are smaller but much better defined, leading to ads that are more relevant to viewers and more effective for companies' marketing products.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 schematically illustrates an endorsement system, in accordance with an embodiment of the invention;

FIG. 2 schematically illustrates a user registration and endorsement workflow, in accordance with an embodiment of the invention;

FIG. 3 schematically illustrates a picture creation workflow, in accordance with an embodiment of the invention;

FIG. 4 schematically illustrates a user endorsement workflow, in accordance with an embodiment of the invention;

FIG. 5 illustrates an example of an architecture of an endorsement system, in accordance with embodiments of the invention;

FIGS. 6 and 7 show functional block diagram illustrations of general purpose computer hardware platforms configured for use with systems provided herein, in accordance with embodiments of the invention; and

FIG. 8-13 are screenshots of an endorsement system and workflow, in accordance with an embodiment of the invention.

### DETAILED DESCRIPTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention.

As described further herein, systems and methods may allow users to display logos or icons of companies, causes or other endorsees within a user's profile picture on a social network. Social networks, as described further herein, may include Facebook, LinkedIn, Myspace, Google (e.g., chat environments), Groupon, or other networks on which a user may interact with other users. The user's profile picture featuring an embedded logo of a company may act as an endorsement by the user of such company. Such endorsement may be viewed by the user's friends, network connections, or other users via a social network. In exchange for the user's endorsement of the company, the user may be compensated with an incentive.

The term “profile”, as used herein, can refer to any electronic material that is prepared by or for a user. In one embodiment, a profile can include one or more images, icons, badges, etc. selected by or for a user. In another embodiment, a profile can include text prepared by or for a use. For example, a profile can include a user's picture and text prepared by the uses. Such text can include information that is descriptive of the user, such as, for example, the user's interests and hobbies.

The term “endorsee”, as used herein, can include one or more brands, persons, causes, organizations, companies or other types of entities, that is (or are) associated with an endorsement. In one embodiment, an endorsee is an entity associated with one or more advertising material (or items). Such advertising material can be displayed on a user's profile, such as on a user's image or an image selected by the user for display on the user's profile. For example, an endorsee can be a company (e.g., a car company, a computer company) wishing to inform buyers of its products. In one embodiment, two or more brands or entities may work together for a “co-promotion” to allow a user's profile to display advertising material reflecting two (or more) brands.

### Endorsement Systems and Methods

In one aspect of the invention, an endorsement system is provided for enabling a user to manage endorsements and promotions. In one embodiment, the endorsement system includes an administration system, the administration system including one or more modules to permit a user to create a profile, manage the user's profile, and manage endorsements.

In embodiments, a system is provided for matching a profile of a user with an endorsee based on predetermined matching criteria, and assigning an endorsement associated with the endorsee to the user. The system can make the endorsement available for display on the user's profile.

In embodiments, the system is provided for enabling a computer-implemented method for associating a profile of a user with an endorsement. In one embodiment, the computer-implemented method comprises matching a profile of a user with an endorsee based on predetermined matching criteria, and assigning an endorsement associated with the endorsee to the user. The endorsement can then be made available for display on the user's profile.

In one embodiment, the system includes a computer system including one or more computers. The one or more computers can include a plurality of computers communicating with one another in a local area network or over the interne. In another embodiment, the system can include one or more computer systems in communication with one or more databases for storing user and endorsee information. In another embodiment, the system can be in communication with one or more subsystems (or modules) for permitting the user to create or modify the user's profile, select one or more endorsements, associated the user's profile with the one or more endorsements, display the one or more endorsements on the user's profile, and select one or more promotional materials (also “promotions” herein).

In one embodiment, the predetermined matching criteria can be selected by the user. In another embodiment, the predetermined matching criteria is based on data relating to the user or on the user's profile. In another embodiment, the predetermined matching criteria can be selected by the endorsee.

In one embodiment, the user's profile is associated with an internet-based system. In another embodiment, the user's profile is associated with an internet-based social network. In another embodiment, the user's profile is capable of associating with an internet-based social network.

In one embodiment, the endorsement image can comprise one or more images selected by the endorsee. For example, the endorsement can include one or more images or logos associated with (or specific to) an endorsee. As another example, the endorsement can include one or more images selected by the endorsee. Such one or more images can include features that are specific to the endorsee.

In one embodiment, upon matching a user with an endorsement (based on user profile information or other related user data), the system makes the endorsement available for display on the user's profile. The display may be the company logo embedded within the user's profile picture. In another embodiment, the system generates a user-specific endorsement for display on the user's profile (or a profile associated with the user). The user-specific endorsement can comprise an advertisement directed at the endorsee. In one embodiment, the user-specific endorsement can include an image selected by the user (such as a picture of the user's or the user's avatar) or selected for the user and authorized by the user and including an image, logo or other advertisement associated with the endorsee.

In one embodiment, the system is configured to provide the user a promotion based on the assignment of the endorsement offer. In another embodiment, the system can provide the user a discount or incentive based on matching of the user's profile information or other user data with the endorsement. For example, the system can provide the user a discount on a product or other incentive. As another example, the system can provide the user a discount at a store or location, such as an interne-based location. In one embodiment, the system provides the user a promotion or incentive (also “promotional offer” herein) by obtaining consent from a merchant to market and advertise an item which may be generally provided by the merchant at an undiscounted price. The merchant can be the endorsee. Next, the system determines an incentive, and such incentive may be, for example, a price that is discounted (or reduced) with respect to the generally undiscounted price. The system then presents the incentive to the user.

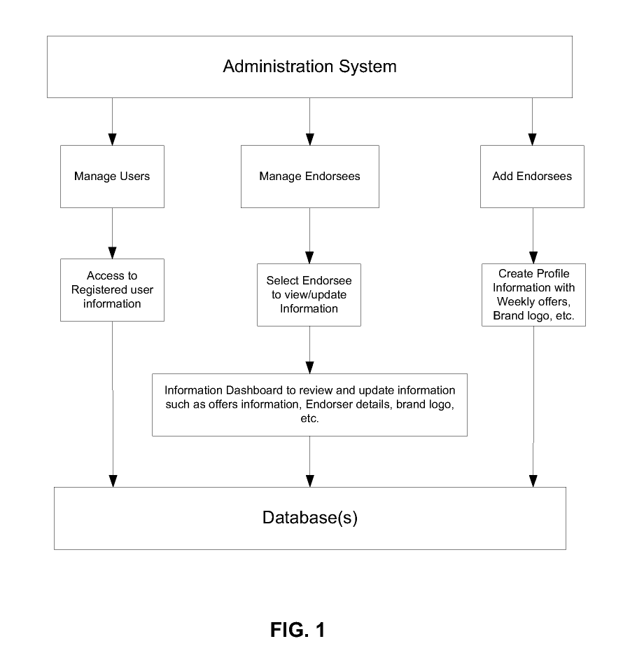

With reference to FIG. 1, a system is shown for associating an endorsement with a user. The system includes an administration system (or subsystem) configured to manage users and endorsees. The administration system can add or remove endorsees and users. The administration system can enable users to access user information. In one embodiment, the administration system can enable users to access registered user information.

With continued reference to FIG. 1, the administration system can enable endorsee to view and/or update endorsee information, including an endorsee profile. In one embodiment, the administration system can enable an endorsee to create or prepare matching criteria to associate an endorsement with a user.

In one embodiment, the system can include an information dashboard to provide a user or endorsee to review and update information, such as promotions, endorser details, brand logos, user images and endorsee images. The information dashboard can communicate with one or more databases for storing and retrieving user and endorser information.

In one embodiment, the system can enable an endorsee to create an endorsee profile, update the endorsee's profile and remove the endorsee's profile. For example, the system may have the ability to remove an endorsee (or brand) in the event that such endorsee is not offering the promotions or incentives that are being provided to users. The system can enable the endorsee to create profile information with promotional offers on a designated interval, such as on an hourly, daily, weekly, monthly or yearly basis.

With continued reference to FIG. 1, in one embodiment, the system can enable a user endorsement profile, update the user's endorsement profile and delete the user's endorsement profile. In another embodiment, the system can enable a user to associate the user's profile with other (i.e., third party) systems and subsystems, including other internet-based systems, including social networks. For example, the system can enable a user to associate the user's profile on the system with the user's profile on a third-party social network (e.g., Facebook®, Twitter®).

In embodiments, the system matches a user with an endorsement based on predetermined matching criteria (or user data). In one embodiment, the matching criteria can include user demographics, such as a user's age, sex (i.e., male or female), income, education, sports interests and alma mater (or other user-specific information). In another embodiment, matching criteria are determined by the system based on the frequency at which user's view certain web sites, buy certain products or visit certain stores (or other behavioral information relating to the user). User data may include how many friends a user has on their social networks, how often they have endorsed products, information relating to past endorsements, whether the user has previously breached endorsement agreements, etc.

In another aspect of the invention, a computer-implemented method is provided for associating a user with an endorsement. The computer-implemented method can be facilitated by system provided herein. Such systems are configured to retrieve user data and information and match users with endorsements based on predetermined matching criteria.

In embodiments, a computer-implemented endorsement method is provided for enabling a user to endorse an endorsee in exchange for a promotion. The computer-implemented method can include registering a user, enabling the user to select an endorsement and permitting the user to create or modify an image (such as an image associated with the user's profile on a third-party social network) to include an endorsement image (such as a company's logo). In one embodiment, each step can be presented to a user in a discrete phase of the endorsement process.

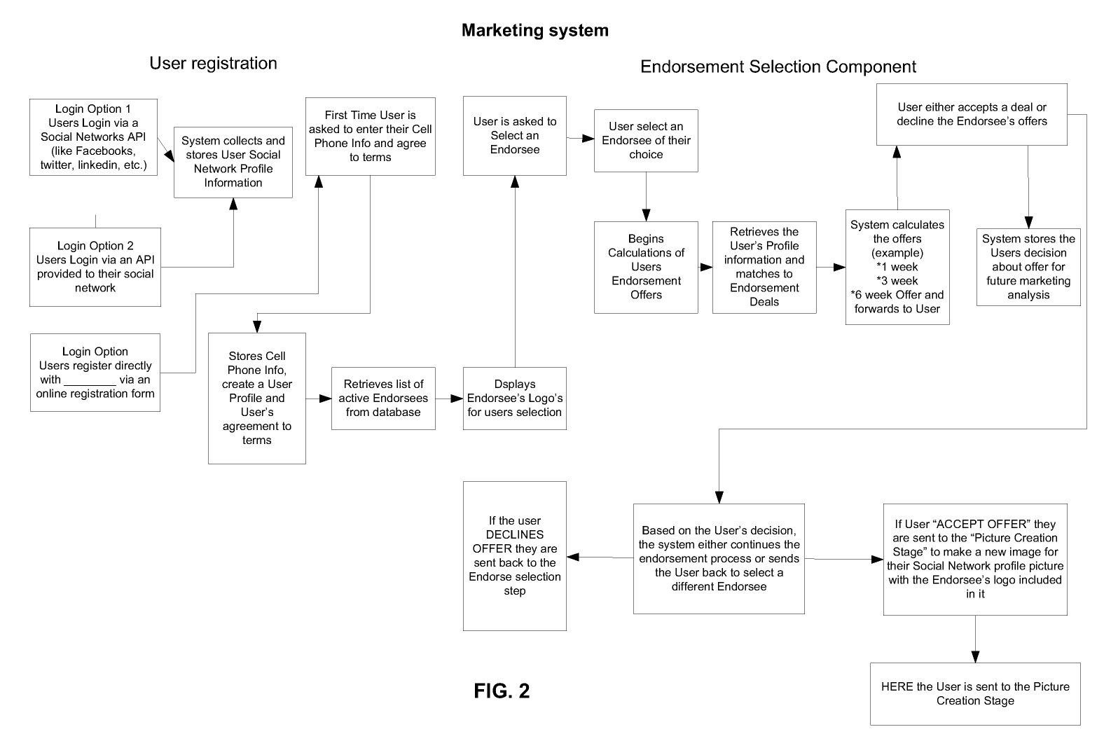

FIG. 2 schematically illustrates a workflow for permitting a user to register with the system. In a first step, during a registration phase, the user logs in to the system and creates a user profile. The user can login via one or more of a social network, an application programming interface (API) provided by the system (or associated with the system) and a subsystem or module associated with the system for permitting the user to register via the interne. Next, the system collects and stores the user's social network information. Such information is stored in the profile created for, and associated with, the user. Next, the system collects the user's personal information, such as cell phone information. Any information collected by the system and related to the user, such as the user's profile, can be stored by the system in one or more databases or storage locations associated with the system. During the registration phase the system retrieves endorsees from one or more databases or storage locations for storing endorsee information. The system then displays one or more endorsees' logos for selection by the user. During the registration phase, the system requests that the user accept the system's terms of use (e.g., user will not display any copyrighted information on the user's profile).

With continued reference to FIG. 2, in an endorsement selection phase, the system asks the user to select an endorsee from the one or more endorsees. Based on the user's selection of an endorsee, the system calculates endorsement offers to provide the user. Next, the system retrieves the user's profile information (or other user data) and matches the endorsement deals (or promotional offers) with the user (or the user's profile). The system then determines the length of time in which an offer is open, such as for the period of an hour, several hours, a day, several days, a week, several weeks, a month, several months, a year, or several years. The system then presents the user the option to accept or decline the offer. The system stores the user's decision in a database or storage location associated with the system.

Next, based on the user's decision, the system either continues the endorsement process or sends the user back to select a different endorsement. The endorsement selection phase can continue until the user accepts a promotion (or endorsement deal). If and when the user selects an endorsee and accepts the endorsement deal associated with the endorsee, the system directs the user to a picture creation phase of the endorsement. In one embodiment, the system may track and record data relating to the user's selections of endorsements, such as how many users have selected a certain endorsement, how many users use the incentives offered by the endorsement, demographic information of users who select certain endorsements, etc. Such information may be utilized by the endorsees.

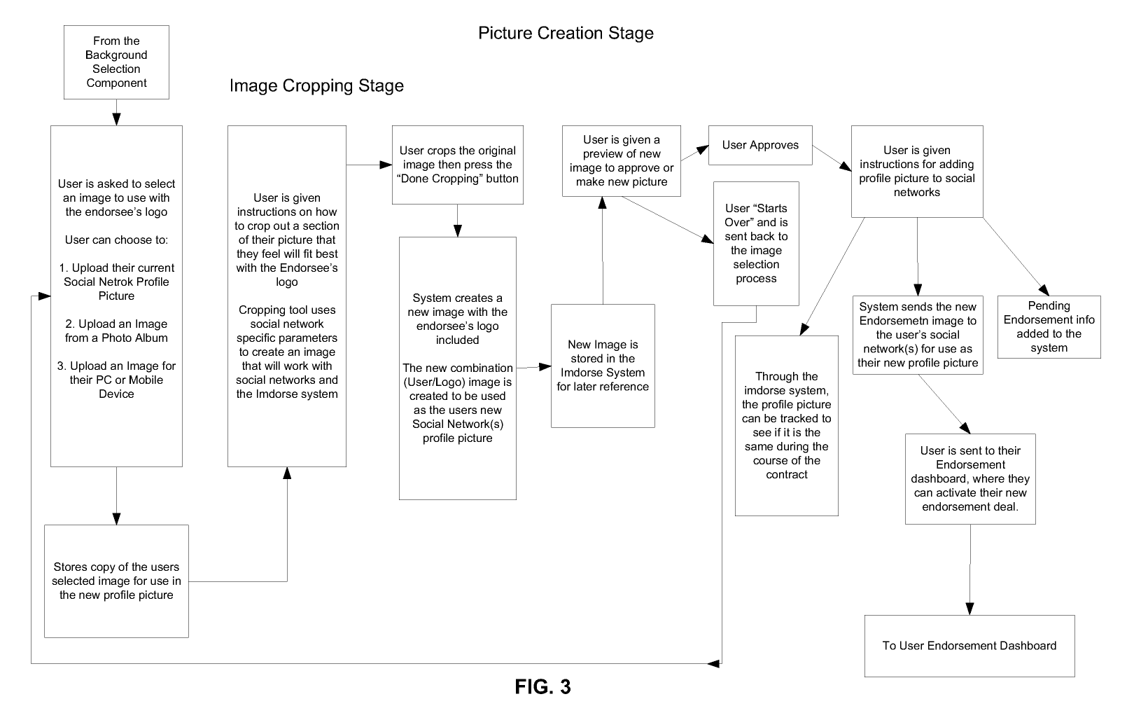

With reference to FIG. 3, a workflow of the picture creation phase (or stage) of the endorsement process is schematically illustrated, in accordance with an embodiment of the invention. From the endorsement selection phase, the system asks the user to select an image to use with the endorsee's logo. The user can upload the user's current social network picture (e.g., profile picture), upload an image from a user's photo album, or upload an image from the user's PC or mobile electronic device, such as Smartphone (e.g., Apple® iPhone, Droid®-based phone, Blackberry®). The system stores a copy of the user's image in one or more databases or storage locations.

With continued reference to FIG. 3, in an image cropping phase or stage, the user is provided instructions on how to crop out a section of the user's picture that the user feels best fits with the endorsee's logo. In one embodiment, the image modification tool uses social network-specific parameters to create an image that will create an image that will work with social networks and the system. The user then modifies the original image and the system creates a new image with the endorsee's logo (or other advertisement) included on (or embedded within) the image. The new combination of the user's image having the endorsee's logo is created for use as the user's new profile picture. In one embodiment, the new combination is provided for use with the user's social network (e.g., Facebook®, Twitter®). The system saves (or stores) the new combination of the user's image having the endorsee's logo (also “new image” herein) on one or more databases(s) or storage locations.

Next, the user is given a preview of the new image to approve the new image or elect to create new combination. If the user does not approve the new image, the system directs the user to the start of the picture creation phase. If the user approves the new image, the user is given instructions for adding the profile picture to the user's one or more social networks. In one embodiment, the system accesses each of the social networks selected by the user to upload the new image. In another embodiment, the system provides the user the opportunity to register at a new social network and aids in uploading the new image to user's profile at the new social network. In another embodiment, the system sends the new image to the user's social network(s) for use as the user's new profile picture. In another embodiment, once the user has added the new image (also “endorsement image” herein) to the user's social network profile(s), the system adds pending endorsement information to the system. In one embodiment, once the new image has been added to the user's social network profile(s), the system enables the user to take advantage of the promotion selected by the user. In another embodiment, once the new image has been added to the user's social network profile(s), the system enables the user to take advantage of the promotion selected by the user after a predetermined time period, such as after the period of a one or a few hours, several hours, a day, several days, a week, several weeks, a month, several months, a year, several years or immediately. The promotion offered to the user can depend on the length of time the user agrees to display the user's endorsement image. For example, if the user displays the endorsement image for 1 year, the user might be offered a promotion that has a larger discount (or better/greater incentive) with respect to a promotion offered had the user selected a shorter time period (e.g., 1 day) to display the endorsement image. Incentives offered to a user may also be varied based on other user data, including how many social network connections a certain user has or the user's past endorsement activity.

In one embodiment, the system monitors (at predetermined intervals) the user's social network profile(s) to see if the user is abiding by the terms of the contract the user entered into during the user registration stage. In another embodiment, the system monitors the user's profile(s) to see if the user is displaying the new image during the time period the user agreed to display the new image in exchange for a promotion. Next, the user is directed to the endorsement dashboard or phase of the endorsement process.

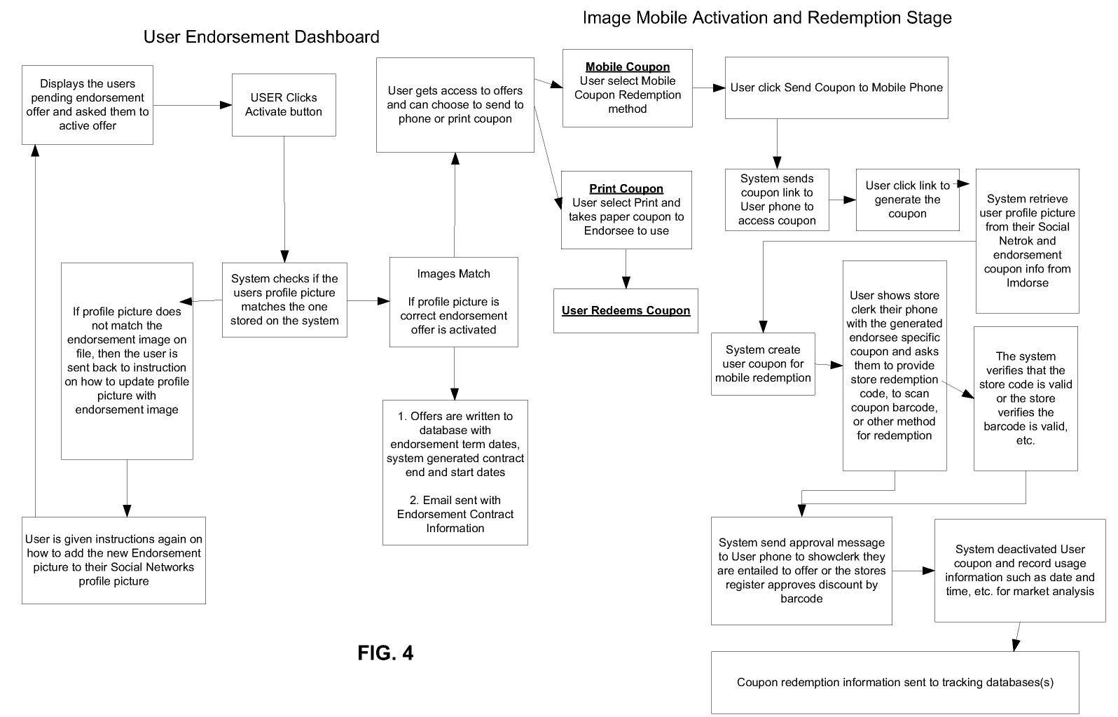

With reference to FIG. 4, a workflow of a user dashboard phase or stage of the endorsement process is illustrated, in accordance with an embodiment of the invention. In one embodiment, the system displays the users pending endorsement offer and asks them whether they would like to use (or activate) the offer. The system checks if the users profile picture matches the new image created by the user, uploaded to one or more social network(s), and stored on the system. If the image does not match, the user is given instructions on how to add the new endorsement picture to the user's social network profile. Alternatively, if the image does not match, the system provides the user the option to create a new endorsement picture to upload to the user's social network profile. If the image matches, the endorsement offer (or promotion) is activated. The system then writes the offer to a database with endorsement term dates, generates a contract and start and end dates for the promotion, and sends the promotion to the user through one or more methods such as electronic mail (“email”), text message, a telephone call or text message with a promotion code, regular mail, including FedEx®, and print the promotion (or coupon having the promotion). In one embodiment, the system can redirect the user to a website associated with the user's promotion, enabling the user to take advantage of the offer provided by the promotion.

In one embodiment, the user can select a mobile coupon option. Under this option, the system sends a coupon link having a link to the promotion to the user's mobile device, such as mobile telephone. The user can click on the link to access the promotion. The system then retrieves the user's profile picture from the social network and endorsement coupon information from the system. The system then creates a user coupon having the endorsement (endorsee-specific coupon) for mobile redemption. The user can use the coupon at a store designated for use by the promotion. The user can show a clerk at the store the user's mobile device such as telephone with the endorsee-specific coupon displayed on a screen of the user's mobile device such as telephone. The store clerk can enable the user to redeem the promotion. For example, if the store clerk verifies that the user's picture on the endorsement matches the user's face, the store clerk can provide the user a redemption code or scan a barcode directly from the user mobile device such as a telephone to enable the user to redeem the promotion at the store. In one embodiment, the system can verify that the store code is valid. In another embodiment, the store can verify that the barcode is valid. Next, the system sends an approval message to the user's phone. The user then shows the user's phone to the store clerk to show the clerk that the user is entitled to the promotion. Alternatively, the store's register can approve the promotion by scanning a barcode on the user's phone, such as a screen of the user's phone. After the user has used the promotion, the system deactivates the user's promotion (if it is a single-use promotion) and records usage information, such as timestamp information, for market analysis. In one embodiment, the user's promotion can be used at predetermined intervals, such as once a day, or once a week, or once a month, or once a year. In such a case, after use, the system can deactivate the user's promotion for a length of time to the point at which the user can once again use the promotion.

### System Architecture

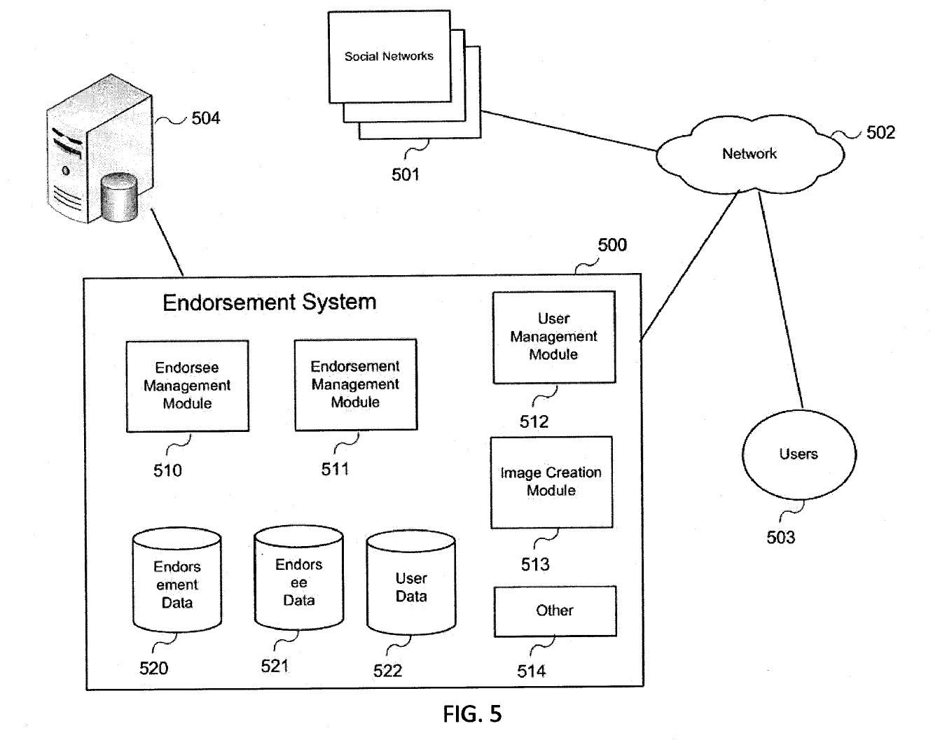

In another aspect of the invention, the endorsement system is configured to communicate with one or more systems and subsystems, storage units, database(s), an intranet and the interne. In one embodiment, the system includes a one or more subsystems (or modules), such as a storage module, which can include one or more databases. FIG. 5 illustrates an example of an architecture of an endorsement system 500, in accordance with embodiments of the invention. In FIG. 5, an endorsement system 500 is illustrated including an endorsee management module 510, endorsement management module 511, user management module 512, image creation module 513, or other modules 514. The endorsement system 500 may track, manage and store certain data including endorsement data 520, endorsee data 521, and user data 522. The endorsement system 500 may be coupled to a server and/or other storage devices 504. The endorsement system 500 may be made available to users 503 over a network 502, such as the Internet. Users 503 may utilize the endorsement system 500 in connection with various social networks 501 as further described herein.

In one embodiment, the system includes random-access memory (RAM) for enabling rapid transfer of information to and from a central processing unit (CPU), and to and from a storage module, such as one or more storage units, including magnetic storage media (i.e., hard disks), flash storage media and optical storage media.

In one embodiment, the system can include one or more of a storage unit, one or more CPUs, one or more RAMs, one or more read-only memories (ROMs), one or more communication ports (COM PORTS), one or more input/output (I/O) modules, such as an I/O interface, a network interface for enabling the system to interact with an intranet, including other systems and subsystems, and the internet, including the World Wide Web. The storage unit can include one or more databases, such as a relational database. In one embodiment, the system further includes a data warehouse for storing information, such as user, endorsee and promotion information. In another embodiment, the system includes a relational database. In another embodiment, the system can include one or more servers, such as, for example, media servers (e.g., image servers) or profile servers.

In one embodiment, the system is configured for data mining and extract, transform and load (ETL) operations, which can permit the system to load information from a raw data source (or mined data) into a data warehouse. The data warehouse can be configured for use with a business intelligence system (e.g., Microstrategy®, Business Objects®).

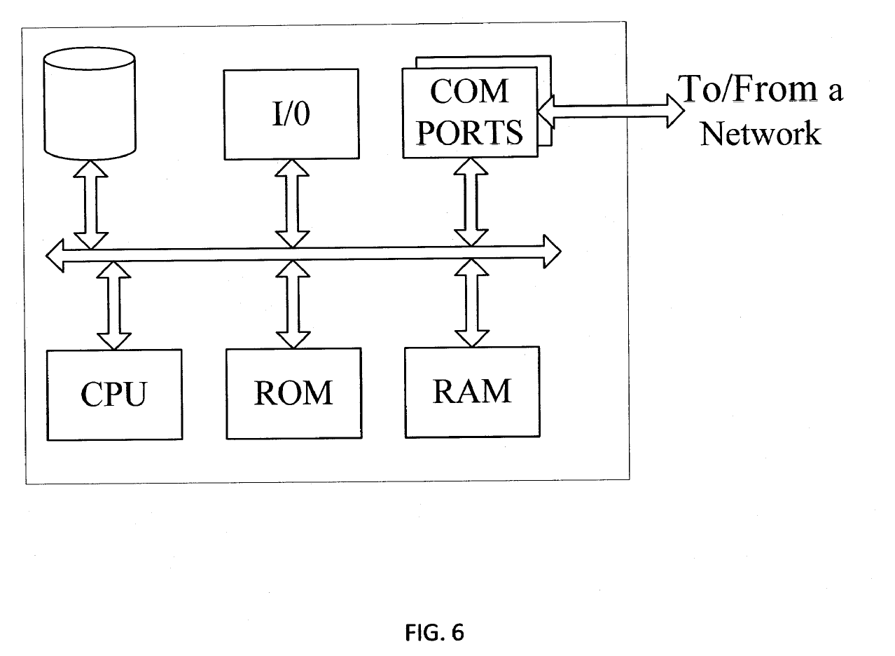

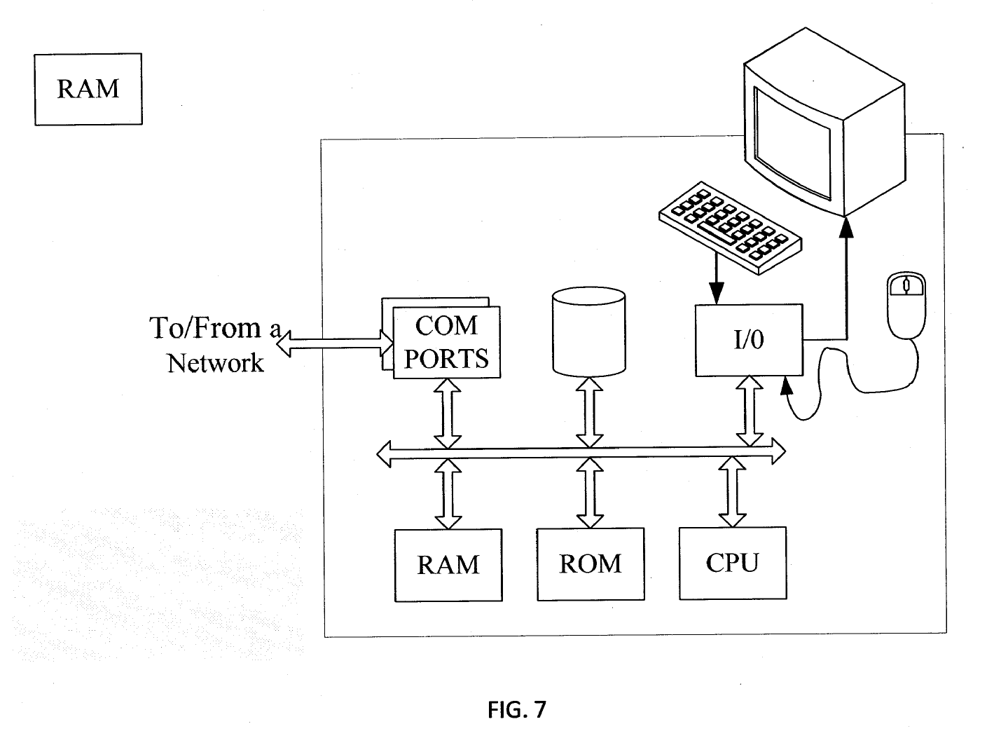

FIGS. 6 and 7 show functional block diagram illustrations of general purpose computer hardware platforms configured for use with systems provided herein. FIG. 6 illustrates an example of a network or host computer platform, as can be used to implement a server, in accordance with an embodiment of the invention. FIG. 7 depicts a computer with user interface elements, as can be used to implement a personal computer or other type of work station or terminal device, in accordance with an embodiment of the invention. In one embodiment, the computer of FIG. 7 can also act as a server if appropriately programmed. It is believed that those skilled in the art are familiar with the structure, programming and general operation of such computer equipment and as a result the drawings should be self-explanatory.

A server, for example, can include a data communication interface for packet data communication. The server can also include a central processing unit (CPU), in the form of one or more processors, for executing program instructions. The server platform can include an internal communication bus, program storage and data storage for various data files to be processed and/or communicated by the server, although the server can receive programming and data via network communications. The hardware elements, operating systems and programming languages of such servers are conventional in nature, and it is presumed that those skilled in the art are adequately familiar therewith. Of course, the server functions can be implemented in a distributed fashion on a number of similar platforms, to distribute the processing load.

Hence, aspects of the methods outlined above can be embodied in programming. Program aspects of the technology can be thought of as “products” or “articles of manufacture” typically in the form of executable code and/or associated data that is carried on or embodied in a type of machine readable medium. “Storage” type media can include any or all of the tangible memory of the computers, processors or the like, or associated modules thereof, such as various semiconductor memories, tape drives, disk drives and the like, which can provide non-transitory storage at any time for the software programming. All or portions of the software can at times be communicated through the Internet or various other telecommunication networks. Such communications, for example, can enable loading of the software from one computer or processor into another, for example, from a management server or host computer into the computer platform of an application server. Thus, another type of media that can bear the software elements includes optical, electrical and electromagnetic waves, such as used across physical interfaces between local devices, through wired and optical landline networks and over various air-links. The physical elements that carry such waves, such as wired or wireless links, optical links or the like, also can be considered as media bearing the software. As used herein, unless restricted to non-transitory, tangible “storage” media, terms such as computer or machine “readable medium” refer to any medium that participates in providing instructions to a processor for execution.

Hence, a machine readable medium can take many forms, including but not limited to, a tangible storage medium, a carrier wave medium or physical transmission medium. Non-volatile storage media include, for example, optical or magnetic disks, such as any of the storage devices in any computer(s) or the like, such as can be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media can be involved in carrying one or more sequences of one or more instructions to a processor for execution.

### EXAMPLES

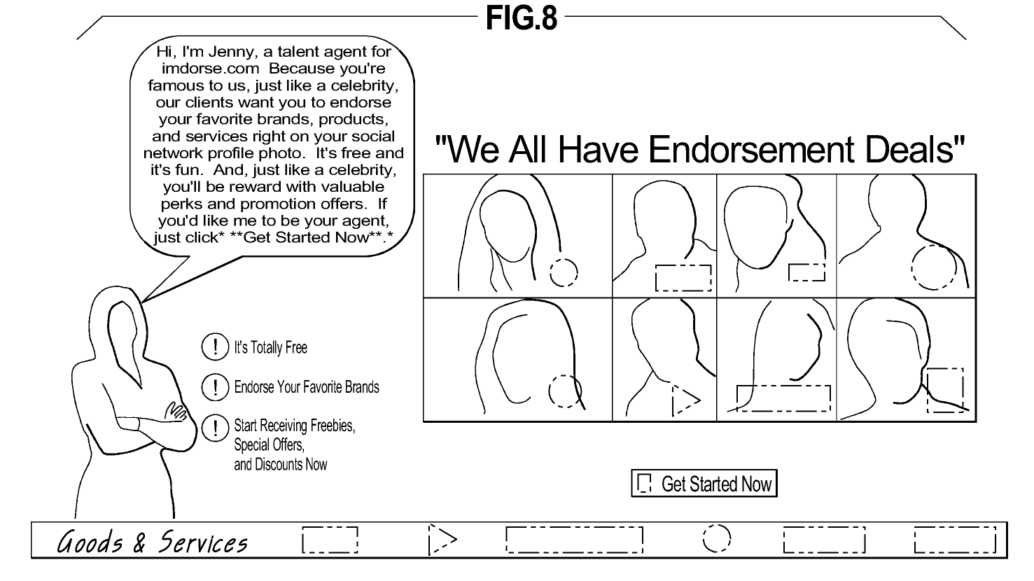

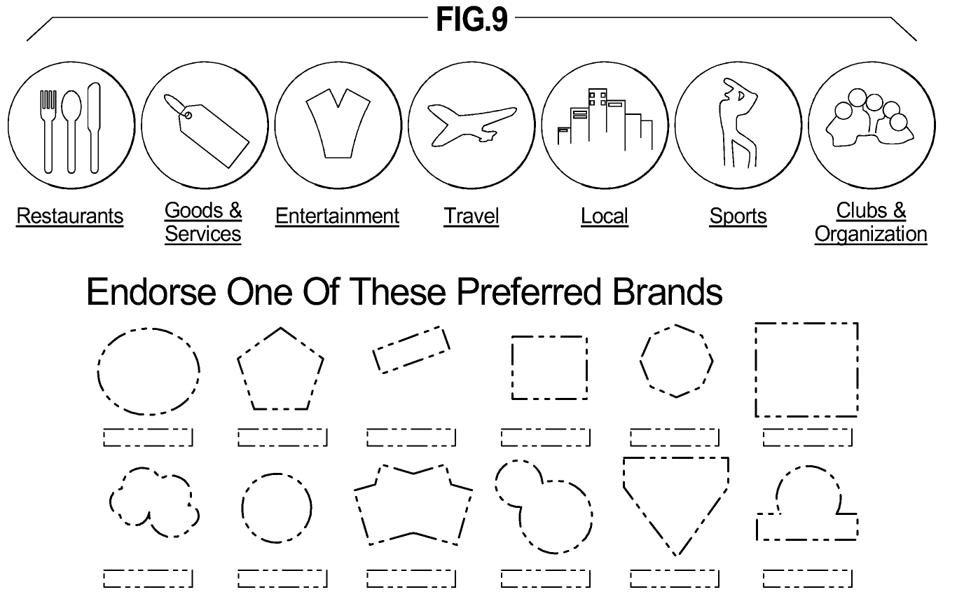

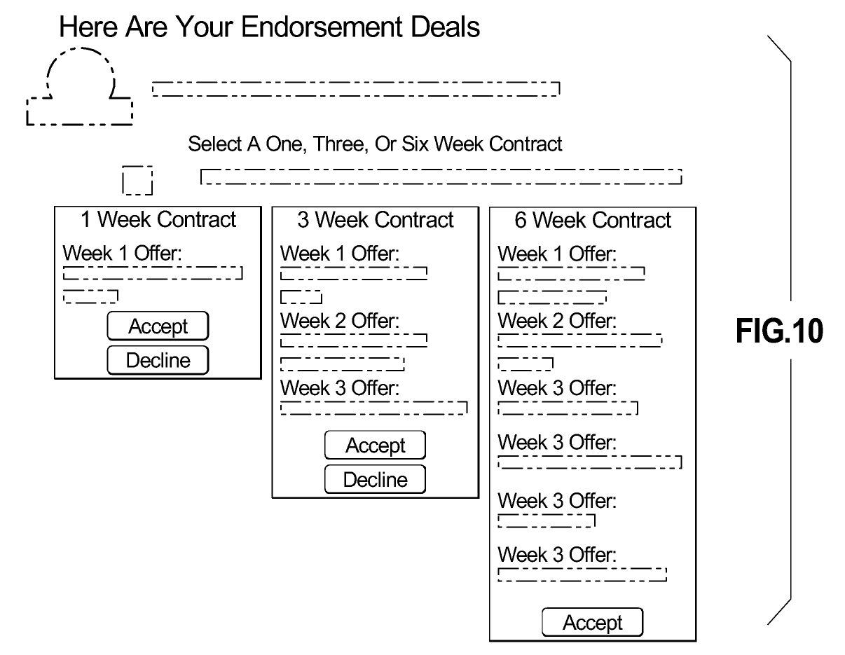

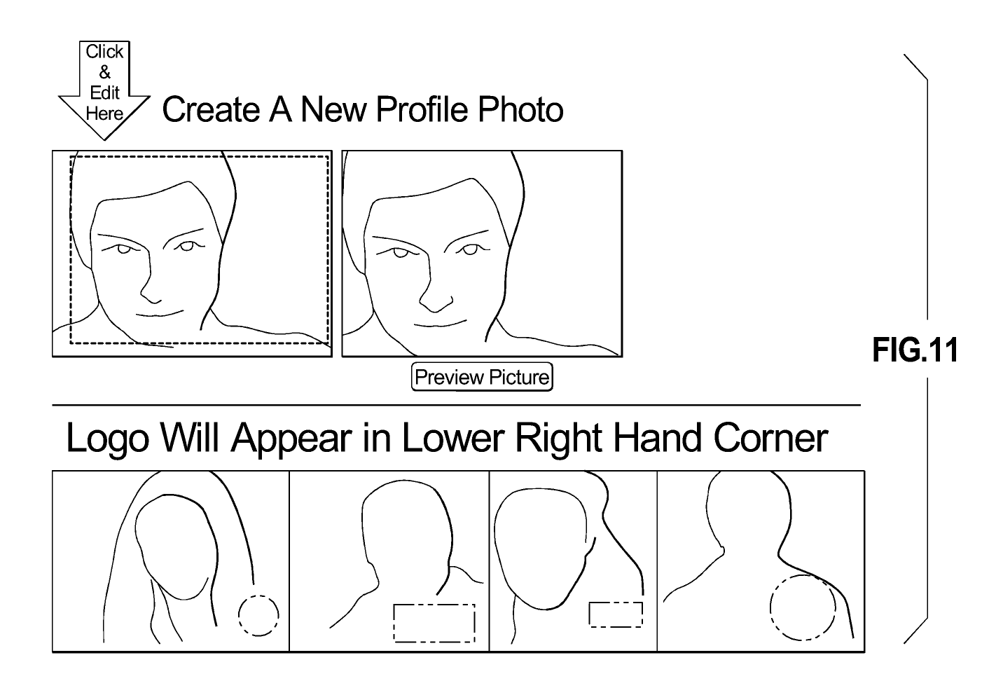

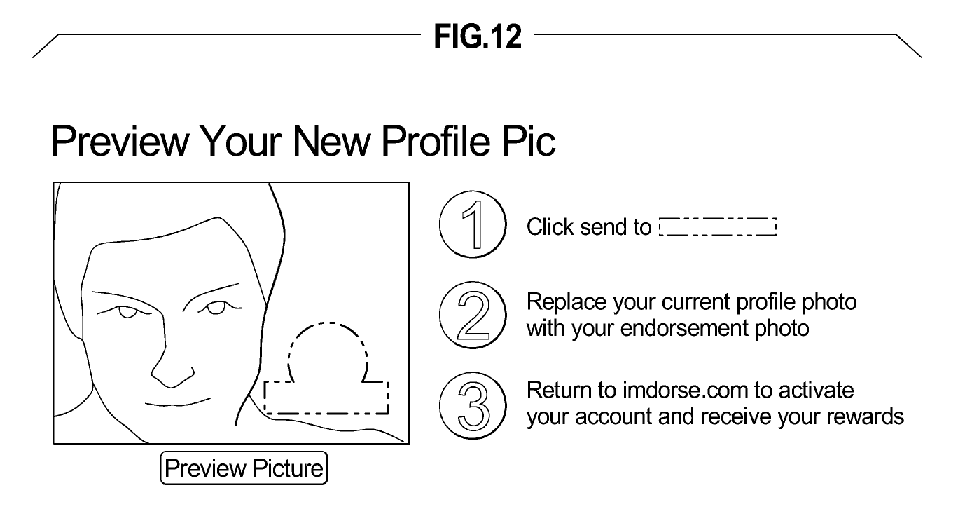

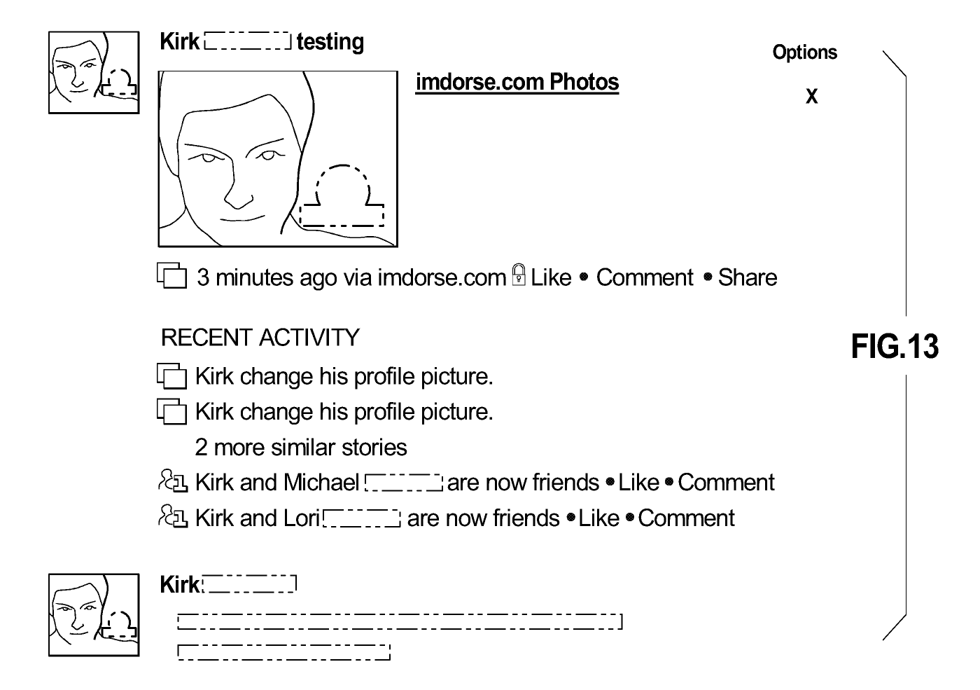

FIG. 8 is a screenshot of a welcome screen of the endorsement system, showing various users having endorsements associated with their profile pictures. FIG. 9 is a screenshot of the endorsement system, showing a user a variety of endorsees the user can elect to endorse. FIG. 10 is a screenshot of the user's endorsement offers or deals. FIG. 11 is a screenshot of the system providing the user the opportunity to create a new endorsement image and preview the endorsement image. FIG. 12 is a screenshot of the user's endorsement, ready to be upload to a social network, such as Facebook®. FIG. 13 is a screenshot of the user's profile at a social network web site, showing the user's endorsement appearing on the user's profile.

Systems and methods of embodiments of the invention can be combined or modified with other systems and methods. For example, systems and methods of embodiments of the invention can be combined or modified with systems and methods described in U.S. Patent Publication No. 2010/0082598 to Steelberg et al. (“ENGINE, SYSTEM AND METHOD FOR GENERATION OF BRAND AFFINITY CONTENT”), U.S. Patent Publication No. 20100287103 to Mason (“SYSTEM AND METHODS FOR DISCOUNT RETAILING”), and U.S. Pat. No. 7,827,574 to Hendricks et al. (“METHOD AND APPARATUS FOR TARGETED ADVERTISING”), which are entirely incorporated herein by reference.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A computer-implemented method for associating a profile of a user with an endorsement, comprising:
matching the profile of a user with an endorsee based on predetermined matching criteria;
assigning an endorsement associated with the endorsee to the user;
making the endorsement available for display on the user's profile; and
providing the user a promotion based on the assignment of the endorsement.

2. The method of claim 1, wherein the profile is associated with an internet-based system.

3. The method of claim 1, wherein the endorsement comprises one or more images selected by the endorsee.

4. The method of claim 1, wherein the profile is associated with an internet-based social network.

5. The method of claim 1, wherein making the endorsement available for display on the user's profile comprises generating a user-specific endorsement.

6. The method of claim 5, wherein the user-specific endorsement comprises an advertisement directed at the endorsee.

7. The method of claim 1, wherein providing the user the promotion comprises:
(a) obtaining consent from a merchant to market and advertise an item originally provided by the merchant at an undiscounted price;
(b) determining an incentive for the item, the incentive offering the item at a discount with respect to the undiscounted price; and
(c) presenting the incentive to the user.

8. A computer-implemented method for associating a profile of a user with an endorsement, comprising:
matching the profile of a user with an endorsee based on predetermined matching criteria;
assigning an endorsement associated with the endorsee to the user; and
making the endorsement available for display on the user's profile.
